(19) United States
(12) Patent Application Publication
(10) Pub. No.: US 2013/0038731 A1
(43) Pub. Date: Feb. 14, 2013

(54) MOVEABLE BACKUP CAMERA

(71) Applicants: Thomas A. Brey, Lake In The Hills, IL (US); Don Peterson, Belvidere, IL (US)

(72) Inventors: Thomas A. Brey, Lake In The Hills, IL (US); Don Peterson, Belvidere, IL (US)

(73) Assignee: CONTINENTAL AUTOMOTIVE SYSTEMS, INC., Deer Park, IL (US)

(21) Appl. No.: 13/205,782

(22) Filed: Aug. 9, 2011

(51) Int. Cl. H04N 7/18

(52) U.S. Cl. 348/148; 348/E07.085

(57) ABSTRACT

A camera that is movable is provided for a vehicle. It can be placed at the rear of a vehicle or at the rear of a towed trailer to capture images that might not be within the driver's field of view. Captured images are modulated onto a radio frequency signal, which is broadcast and picked up by a mating radio frequency receiver, typically located inside the towing vehicle. Captured-picture information on the radio frequency signal is recovered and used to generate an image on a display device that can be seen by the driver. An attaching device is provided to the camera to allow the camera to be attached to the vehicle or a trailer and its location changed as needed. The camera thus provides a method and apparatus for wirelessly conveying to the driver, images in an otherwise obstructed field of view.

### BACKGROUND

A back-up camera refers to a camera mounted at the rear of a vehicle and which is directed rearward of the vehicle in order allow the camera to capture images of objects behind the vehicle as well as outside of a driver's field of view. A display device mounted on the dashboard of the vehicle receives image information from the back-up camera and displays images captured by the camera. A back-up camera thus enables a driver to “see” what is behind the vehicle and outside the driver's field of view.

A problem with prior art back-up cameras is that when a trailer is attached to a vehicle, they are unable to capture images behind the trailer. A back-up camera that is able to “see” behind the vehicle as well behind a trailer attached to the vehicle would be an improvement over the prior art.

### BRIEF DESCRIPTION OF THE DRAWINGS

FIG. 1 depicts a trailer attached to a motor vehicle and obscuring the field of view of a vehicle-mounted back-up camera;

FIG. 2 is a block diagram of a moveable back-up camera; and

FIG. 3 depicts steps of a method for using a movable camera.

### DETAILED DESCRIPTION

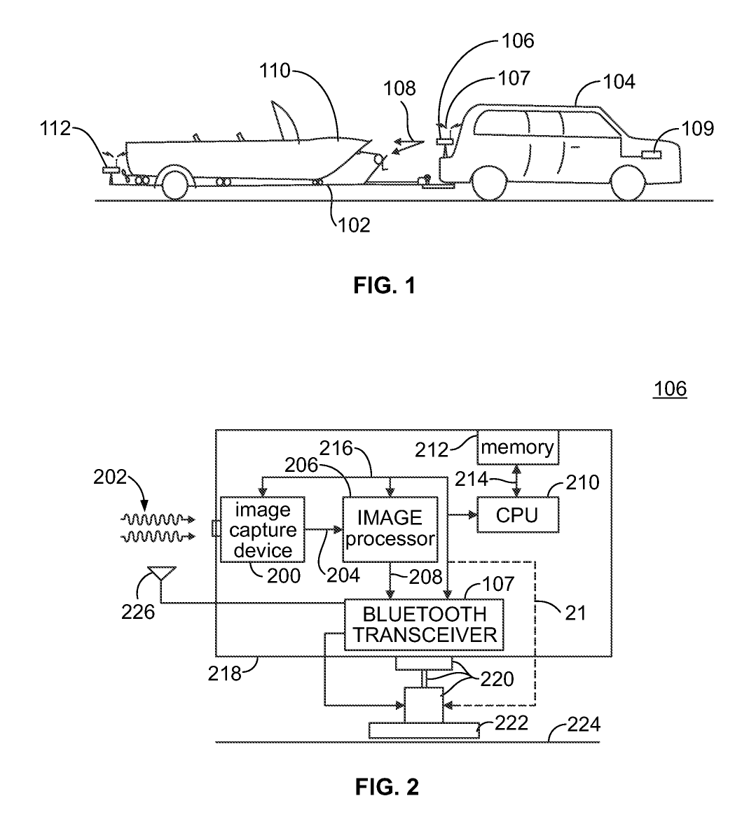

FIG. 1 depicts a trailer 102 attached to a passenger car or other motor vehicle 104. The vehicle 104 has a back-up camera 106 attached to its rear bumper. The camera 106 is directed rearwardly 108 from the vehicle 104 and is therefore able to capture images of objects behind the vehicle 104.

The camera 106 is a digital camera. It outputs digital data that represents one or more images captured on a conventional image capture device. Images are captured as frames. The camera 106 outputs digital data representing a captured image frame, to a conventional Bluetooth transceiver, not visible in FIG. 1 because of its small size as well as its location inside the camera's body. The Bluetooth transceiver broadcasts radio frequency signals 107 to a corresponding Bluetooth transceiver 109 mounted in the vehicle 104. The signals broadcast from the Bluetooth transceiver in the camera 106 carry the digital data that represents a captured image. The camera 106 and its associated Bluetooth transceiver thus communicate wirelessly with a Bluetooth transceiver 109 in the vehicle. The digital data representing a captured image is recovered in the vehicle-mounted transceiver 109 and from there, provided to a conventional display device mounted in the passenger compartment of the vehicle 104.

The wireless communications carried-out between the camera 107 and its mating Bluetooth transceiver 109 are described in the Applicant's co-pending patent application entitled “Smart Trailer,” which is filed contemporaneously herewith and identified by application Ser. No. ______. The “Smart Trailer” patent application is also identified by the Applicant's docket number 2011P713US. The entire content of the “Smart Trailer” application is incorporated herein by reference.

When the trailer 102 is attached to the vehicle 104 and carrying a load 110 that blocks the field of view of the camera 106, the camera 106 is configured to be relocated from the vehicle 104 to a location behind the trailer and behind the trailer's load where the camera 106 can capture images of objects behind the trailer and its load and which would otherwise be blocked from the driver's view. The camera 106 is thus made moveable by an attachment mechanism, also referred to herein as an attaching device 114 that is configured to enable the camera 106 to be attached and detached from the exterior surface of a first vehicle such as an automobile or truck and to be attached to a different surface of a different vehicle, typically a trailer attached to the first vehicle or a load riding on a trailer. Different attachment mechanisms described below enable the camera to be attachable and detachable to and from a vehicle surface, whether the surface be one of a tow vehicle 104, the trailer 102 or a load 110 carried on the trailer.

In one embodiment the attaching device 114 is a hook and loop fastener, an example of which is a VELCRO® fastener. In another embodiment the attaching device can be a magnet, suction cup or an elastic strap. In yet another embodiment the attaching device can be a metallic strap or an adhesive or custom cradle that is fixed to the trailer to which the camera docks.

FIG. 2 is a block diagram of the moveable camera 106 depicted in FIG. 1. The camera 106 is comprised of a conventional image capture device 200. Light rays 202 from objects in front of the image capture device 200 are converted to digital signals that represent the captured image. Digital data or digital signals generated by the image capture device and which represent one or more image frames, are herein after referred to collectively as a signal 204, which is output from the image capture device to an image processor 206. The raw image files produced by the image capture device 200 are processed by the image processor 206 to crop or resize an original image, adjust color and improve image quality and eliminate visual artifacts. Image data processing is well-known in the prior art. Hardware devices and software methodology to perform such functions are by themselves also known in the art. For brevity, the depiction of such hardware and/or methodologies is omitted for brevity.

The output 208 from the image processor 206 is provided to a conventional Bluetooth transceiver 107. The terms, Bluetooth and Bluetooth wireless technology are terms used to describe the technology that was originally developed by the Bluetooth Special Interest Group (SIG). It defines a wireless communication link, operating in the unlicensed industrial, scientific, and medical (ISM) band at 2.4 GHz using a frequency hopping transceiver. The link protocol is based on time slots.

The Bluetooth transceiver 107 receives a signal 208 from the image processor 206. It modulates the signal from the image processor 206 onto a radio frequency carrier, which it broadcasts as short-range radio frequency signals. Such signals, when received by a mating or corresponding Bluetooth transceiver, are demodulated and the signals representing the captured image recovered in the Bluetooth-receiving device using techniques well-known in the art.

The image capture device 200, image processor 206 and the Bluetooth transceiver 107 are controlled by a central processor unit or CPU 210. The CPU 210 executes program instructions stored in a memory device 212, which is coupled to the CPU via a conventional address/data/control bus 214. The CPU 210 thus effectuates control over the capture device 200, image processor 206 and Bluetooth transceiver 107 via an external and separate control bus 216.

Importantly, the camera components depicted in FIG. 2 are enclosed within a case or housing 218. The case 218 is attached to a servo-motor 220 which is in turn mounted to or attached to one of the aforementioned attaching devices 222. The attaching device 222 is configured to attach and detach the camera to and from the exterior surface 224 of a vehicle such as the trailer, its load, or a tow vehicle.

In the embodiment shown in FIG. 2 the Bluetooth transceiver 107 is configured to control the servo-motor 220 using signals that the Bluetooth transceiver 107 receives via its antenna 226. Such signals are typically generated from within the vehicle by the vehicle operator in order to direct the camera as needed. The camera can thus be controlled remotely, e.g., from within a tow vehicle, by its receiving control signals carried on a radio frequency signal.

In an alternate embodiment, the CPU 210 is configured to control the servo-motor by connecting the servo-motor to the aforementioned address/data/control bus 216.

As described above, in a preferred embodiment the radio frequency transceivers are compliant with the Bluetooth communications standard and derivatives thereof. In an alternate embodiment radio frequency communications can be effectuated by one or more of the I.E.E.E. 801.XXX communications standards, such as 802.11(a), (b), (g) and (n) as well as derivatives thereof. Examples of such communications standards include the nearly ubiquitous WI-FI communications standards.

In one embodiment, operating power for the camera 106 is provided by the vehicle to which it is attached. Such power can be readily obtained by a conventional prior art trailer connector. In an alternate embodiment however power to the devices can be supplied by a battery located in or attached to the camera housing 218.

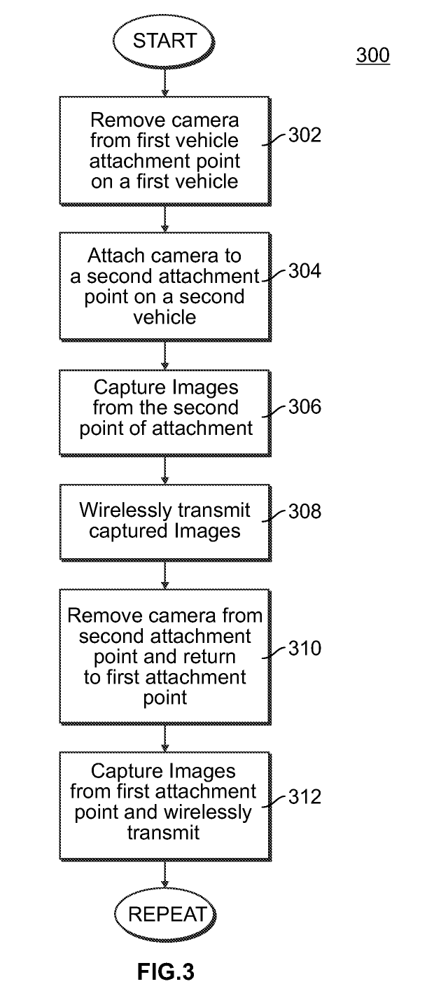

FIG. 3 depicts steps of a method 300 for using the movable camera described above.

In a first step 302, a camera such as the one described above, which is already attached to a first vehicle at a point of attachment such as one of the attachment mechanisms described above, is removed from a vehicle by an individual, such as the vehicle's driver. At step 304, the camera is attached to a second and different attachment mechanism located on a second vehicle, typically embodied as a trailer being towed by the first vehicle. At step 306, the camera captures image frames of areas behind the first vehicle and behind the second vehicle, which areas are obscured from the driver's field of view. In step 308, captured images are transmitted wirelessly from the camera, received by a receiver in the first vehicle and displayed on a display device. In one embodiment, step 308 includes a step of remotely controlling the camera from within the first vehicle in order to allow a driver or other operator in the first vehicle to pan and zoom the camera as needed. At step 310, the camera can be removed from its point of attachment to the second vehicle and be re-attached to a point of attachment to the first vehicle and used thereafter to “see” behind the first vehicle. Images captured from the first point of attachment on the first vehicle can thereafter be captured as shown in step 312. The process depicted in FIG. 3 can thereafter be repeated as needed, i.e., depending on the need to “see” behind a vehicle or a trailer attached to the vehicle.

The foregoing description is for purposes of illustration only. The true scope of the invention is set forth in the appurtenant claims.

What is claimed is:

1. A device for capturing images from obscured fields of view, the device comprising:
a. a camera configured to generate a first signal representing a captured image;
b. a radio frequency transmitter coupled to the camera and receiving the first signal representing a captured image; the radio frequency transmitter configured to transmit short-range radio frequency signals carrying the first signal; and
c. an attaching device, configured to attach and detach the camera and radio frequency transmitter to and from an exterior surface of a vehicle.

2. The device of claim 1, wherein the attaching device comprises a hook and loop fastener.

3. The device of claim 1, wherein the attaching device comprises a magnet.

4. The device of claim 1, wherein the attaching device comprises a suction cup.

5. The device of claim 1, wherein the attaching device comprises an elastic strap.

6. The device of claim 1, wherein the attaching device comprises a metallic strap.

7. The device of claim 1, wherein the radio frequency transmitter is compliant with the Bluetooth communications standard and derivatives thereof.

8. The device of claim 1, wherein the radio frequency transmitter is compliant with the I.E.E.E. 801.xxx communications standards and derivatives thereof.

9. The device of claim 1, further comprising:
a. a servo motor coupled between the camera and attaching device and configured to rotate the camera relative to the attaching device.

10. The device of claim 9, further comprising:
a. a radio frequency receiver coupled to the servo motor and capable of receiving radio frequency signals carrying control commands for the servo motor, the radio frequency receiver being capable of providing servo motor control commands thereto.

11. The device of claim 1, wherein the vehicle is a trailer.

12. The device of claim 1, further comprising a battery within the housing and providing electrical energy to the radio frequency transmitter.

13. A camera configured for selective placement and operation on a motor vehicle or a trailer attached to the motor vehicle, the camera comprising:
a. an attachment mechanism for removably attaching the camera to vehicles;
b. a transmitter for wirelessly images captured by the camera to a receiver coupled to at least a first vehicle, the first vehicle being configured to display images captured by the camera on a display device.

14. The camera of claim 13, wherein the camera includes a receiver, configured to receive control signals for remotely controlling the operation of the camera.

15. The camera of claim 13, wherein the camera is battery powered.

16. A method comprising:
a. detaching a movable camera from a first point of removable attachment on a first vehicle, the camera being configured to be removably attached to the first vehicle at the first point of removable attachment, detached from the first vehicle, and removably attached to a second vehicle at a second point of removable attachment;
b. removably attaching the movable camera to the second point of removable attachment on the second vehicle; and
c. while the movable camera is attached on the second vehicle:
i. capturing an image with the movable camera, and
ii. wirelessly transmitting the captured image.

17. The method of claim 15, further comprising the steps of:
a. operating the camera at the second point of attachment to capture a first image from an obscured field of view.

18. The method of claim 15, further comprising the step of remotely controlling the camera from within the first vehicle.

19. The method of claim 15, wherein the step of attaching the camera to the second point of attachment occurs after capturing an image from the first point to attachment by using the camera while the camera is attached to the first point of attachment.

20. The method of claim 15, wherein the camera is configured to wirelessly transmit captured images.
